(19) United States
(12) Patent Application Publication
(10) Pub. No.: US 2011/0029930 A1
(43) Pub. Date: Feb. 3, 2011

(54) DISTRIBUTED PROCESSING DEVICE AND DISTRIBUTED PROCESSING METHOD

(75) Inventors: Konosuke Watanabe, Kanagawa (JP); Akira Iguchi, Kanagawa (JP); Goh Uemura, Kanagawa (JP); Ken Kawakami, Kanagawa (JP)

Correspondence Address: SPRINKLE IP LAW GROUP, 1301 W. 25TH STREET, SUITE 408, AUSTIN, TX, 78705, US

(73) Assignee: Kabushiki Kaisha Toshiba, Tokyo (JP)

(21) Appl. No.: 12/818,070

(22) Filed: Jun. 17, 2010

(30) Foreign Application Priority Data
Jul. 29, 2009 (JP) JP 2009-176868

(51) Int. Cl. G06F 3/048; G06F 9/46

(52) U.S. Cl. 715/846; 718/102

(57) ABSTRACT

A distributed processing device includes a GUI generating section configured to generate a job execution folder in which a program file of a program used for distributed processing and a processor file corresponding to a computational resource for executing the distributed processing are to be put and to display the job execution folder on a display device, and a file processing section configured to give an instruction for an execution of the distributed processing if the program file and the processor file which are required for executing the distributed processing are put in the job execution folder.

### CROSS-REFERENCE TO RELATED APPLICATION(S)

This application is based upon and claims the benefit of priority from Japanese Patent Application No. 2009-176868 filed in Japan on Jul. 29, 2009; the entire contents of which are incorporated herein by this reference.

### BACKGROUND

1. Field

The present invention relates to a distributed processing device and a distributed processing method, and particularly to a distributed processing device and a distributed processing method for performing distributed processing using a graphical user interface.

2. Description of Related Art

Conventionally, a primary object of a job management system used in a large-scale computer, a PC cluster, a grid system or the like for managing distributed processing is to share a computational resource fairly and efficiently among a plurality of users. To this end, job management is performed by providing queues by which computers or groups of computers are temporally or spatially divided based on a time slot or a maximum number of processors which can be simultaneously used, and assigning respective user jobs to them, so that distributed jobs of different users are prevented as much as possible from interfering with each other.

A job execution schedule management method for performing job management as described above has been proposed in, for example, Japanese Patent Application Laid-Open Publication No. 11-96122.

In this job execution schedule management method, execution, control, and monitoring of a job are performed through operation of a command line, or a dedicated client software or web browser. Therefore, in order to execute distributed processing, a user needs to learn a required specific concept and operation of special software. In other words, a user is required to realize a specific concept such as a queue and know how to use special software in order to execute or manage distributed processing. Therefore, there is a problem that it is not easy to perform execution or management of distributed processing.

### BRIEF DESCRIPTION OF THE DRAWINGS

FIG. 1 is an explanatory diagram illustrating a configuration of a distributed processing system according to a first embodiment of the present invention;

FIG. 2 is an explanatory diagram illustrating a configuration of software of a PC 110;

FIG. 3 is an explanatory diagram illustrating a configuration of a distributed processing device;

FIG. 4 is an explanatory diagram illustrating an example in which a file system provided by a file processing section is displayed on a display section through a GUI;

FIG. 5 is a flowchart illustrating an example of a flow of distributed processing;

FIG. 6 is an explanatory diagram illustrating a state before start of distributed processing;

FIG. 7 is an explanatory diagram illustrating a state at a time when distributed processing is started;

FIG. 8 is a flowchart illustrating an example of a flow of processing in a case where an output file is read out;

FIG. 9 is an explanatory diagram illustrating a state in which a processor file has been moved out from a job execution folder;

FIG. 10 is an explanatory diagram illustrating a state in which all processor files have been taken out from a job execution folder;

FIG. 11 is an explanatory diagram illustrating a state in which computational resources different from used computational resources have been copied into a job execution folder;

FIG. 12 is a flowchart illustrating an example of a flow of processing for reconfiguration of distributed processing;

FIG. 13 is a flowchart illustrating an example of processing during suspension of distributed processing;

FIG. 14 is an explanatory diagram illustrating a state of a job execution folder at a time when distributed processing is completed;

FIG. 15 is an explanatory diagram illustrating a state in which a virtual file has been generated;

FIG. 16 is an explanatory diagram illustrating a state in which computational resources are used simultaneously;

FIG. 17 is an explanatory diagram illustrating a state in which reservation files have been generated;

FIG. 18 is a flowchart illustrating an example of a flow of generation processing of a snapshot file;

FIG. 19 is a flowchart illustrating an example of a flow of processing of reading out a snapshot file;

FIG. 20 is an explanatory diagram illustrating a state in which a configuration file has been placed in a job execution folder;

FIG. 21 A is an explanatory diagram illustrating an example of a progress status presentation file;

FIG. 21B is an explanatory diagram illustrating an example of the progress status presentation file;

FIG. 21C is an explanatory diagram illustrating an example of the progress status presentation file;

FIG. 22 is a flowchart illustrating an example of a flow of generation processing of a progress status presentation file;

FIG. 23A is an explanatory diagram illustrating a state in which a computational resource information presentation file has been generated;

FIG. 23B is an explanatory diagram illustrating a state in which a computational resource information presentation file has been generated;

FIG. 23C is an explanatory diagram illustrating a state in which a computational resource information presentation file has been generated;

FIG. 24 is an explanatory diagram illustrating a state in which a virtual file has been generated; and

FIG. 25 is an explanatory diagram illustrating an example in which a processor management folder is hierarchized.

### DETAILED DESCRIPTION

Hereinafter, embodiments of the present invention will be described in detail with reference to the drawings.

### First Embodiment

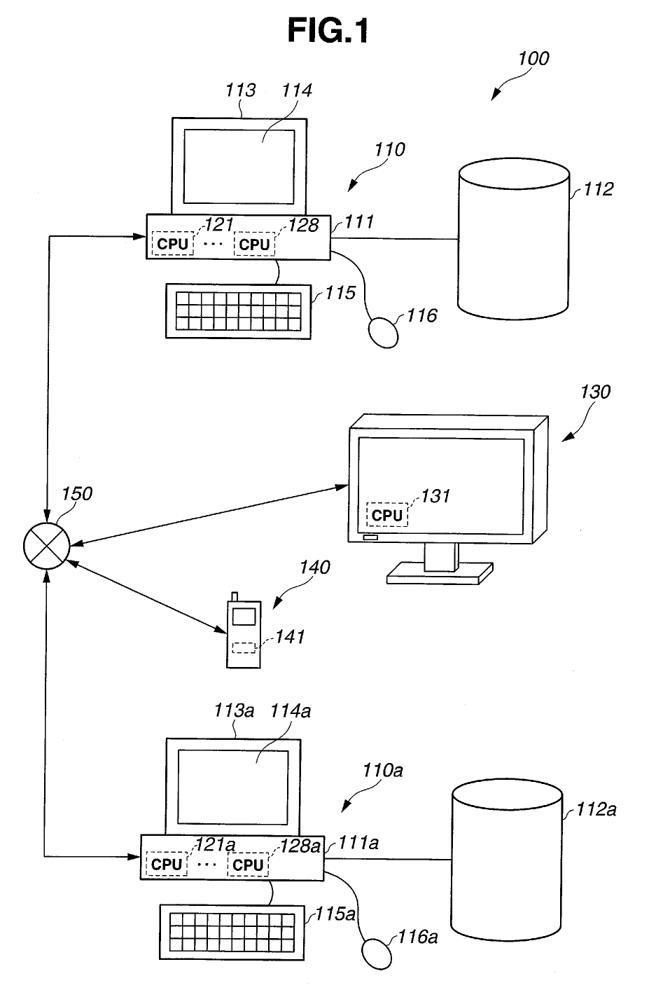

First, a configuration of a distributed processing system according to a first embodiment will be described based on FIG. 1. FIG. 1 is an explanatory diagram illustrating the configuration of the distributed processing system according to the first embodiment of the present invention.

As shown in FIG. 1, a distributed processing system 100 includes personal computers (hereinafter referred to as PCs) 110 and 110a, a television device 130, a portable telephone terminal 140, and a network 150.

The PC 110, the PC 110a, the television device 130, and the portable telephone terminal 140 are connected with each other through the network 150.

The PC 110 includes a main body device 111, a storage device 112, a display device 113 including a display section 114, a keyboard 115, and a mouse 116.

The main body device 111 includes a plurality of central processing units (hereinafter referred to as CPUs), which are eight CPUs 121 to 128 in this embodiment. The PC 110a has components similar to those of the PC 110, and a description thereof will be omitted.

The television device 130 includes a CPU 131, and the portable telephone terminal 140 includes a CPU 141.

A user operates the keyboard 115 or the mouse 116 of the PC 110 such that any one or more of the CPUs 121 to 128 as computational resources give an instruction for an execution of distributed processing to be described later. The CPUs 121 to 128 are computational resources for executing the later described distributed processing respectively. The computational resources for executing the distributed processing are not limited to the CPUs 121 to 128, and may be any of CPUs 121a to 128a of the PC 110a, the CPU 131 of the television device 130, and the CPU 141 of the portable telephone terminal 140 which are connected through the network 150. Also, the computational resources for executing the distributed processing are not limited to the CPUs 121 to 128, and may be a GPU (Graphics Processing Unit) or a DSP (Digital Signal Processor).

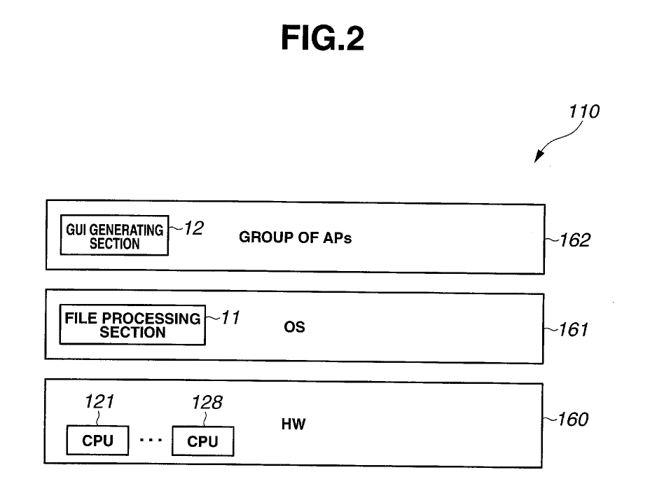

FIG. 2 is an explanatory diagram illustrating a configuration of software of the PC 110.

As shown in FIG. 2, the PC 110 includes hardware (hereinafter referred to as HW) 160 including the CPUs 121 to 128, and a group of programs to be executed on the HW 160. The group of programs includes an operating system (hereinafter referred to as an OS) 161 having a file processing section 11 to be described later, and a group of application programs (hereinafter referred to as APs) 162 having a GUI generation program (hereinafter referred to as a GUI generating section) 12 configured to generate a graphical user interface (hereinafter referred to as a GUI) to be described later. As described later, the GUI generating section 12 generates a job execution folder and displays a GUI for presenting the job execution folder to a user on the display section 114 of the display device 113. In the job execution folder, a program file used for distributed processing and a processor file corresponding to a computational resource for executing the distributed processing are put.

The OS 161 and the group of APs 162 are executed on the HW 160 to construct a distributed processing device to be described later.

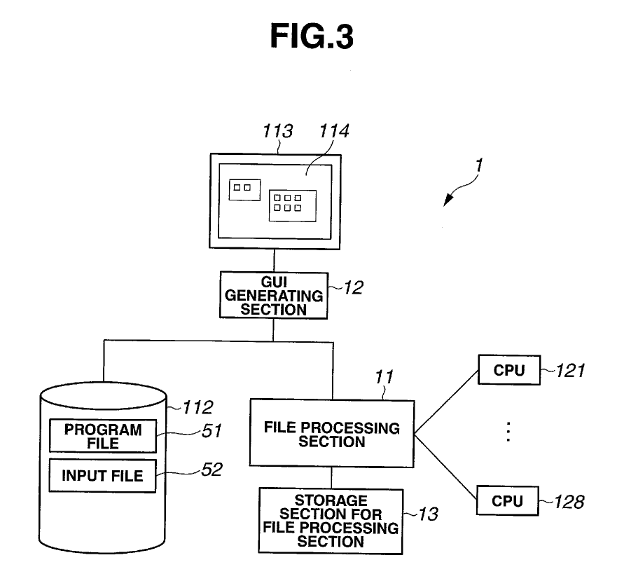

FIG. 3 is an explanatory diagram illustrating a configuration of a distributed processing device.

As shown in FIG. 3, a distributed processing device 1 includes the file processing section 11, the GUI generating section 12, a storage section 13 for the file processing section, the CPUs 121 to 128 as computational resources, and the storage device 112.

The file processing section 11 is implemented as a specific file system in the OS 161, and provides a function corresponding to file operation for managing distributed processing. As with a typical file system, the file processing section 11 supports reading, writing and the like of files, which can be made to look to a user as if on a part of a disk that can be used though the GUI generating section 12 when recognized from the PC 111 used as a terminal.

The file processing section 11 provides a processor file which represents a computational resource as an icon of a file. At an initial state, the file processing section 11 presents this processor file to a user by displaying the processor file in a processor management folder that is a special folder owned by the file processing section 11.

In addition, the file processing section 11 provides a job management folder that is a special folder, and recognizes and manages a folder (hereinafter referred to as a job execution folder) created under the job management folder as individual distributed processing. Then, the file processing section 11 performs an operation on the distributed processing based on copying of a program file 51, an input file 52, and a processor file into the job execution folder through the GUI generating section 12.

Further, the file processing section 11 provides a function for making an output file of a distributed processing result look as if the output file is under the job execution folder, although the output file is actually generated in the storage device 112 directly associated with a computational resource.

Operation of the file processing section 11 is achieved by detecting a file operation on a file or a folder provided by the file processing section 11. For example, in a case where the file processing section 11 is implemented on Linux (R), the file processing section 11 is implemented as a block device, and distributed job management is performed by a file operation corresponding to a system call such as open, close, mkdir, or unlink. Although management of distributed processing is performed using a folder in the present embodiment, management of distributed processing may be performed using, for example, a directory instead of the folder.

When the GUI generating section 12 performs management of distributed processing using the distributed processing device 1, the GUI generating section 12 operates on the PC 110 used as a terminal, and handles all interactions between a user and the distributed processing device 1. The GUI generating section 12 is attached to the PC 110 which can be used as a terminal, and is a typical interface supporting basic operations such as list view, move, copy and deletion of a file and a folder.

In the storage section 13 for the file processing section, the program file 51, the input file 52 and the like copied into the job execution folder are stored by the file processing section 11. In a case where the file processing section 11 operates on the PC 110 or the like case, a part of free space of the storage device 112 may be used instead as a storage area for the file processing section 11 without the storage section 13 for the file processing section.

Each of the CPUs 121 to 128 is a computational resource which can be used in distributed processing through the PC 110, and is an object which executes distributed processing. A computational resource may be another CPU connected through the network 150, for example, the CPU 131 of the television device 130.

In the storage device 112, the program file 51 and the input file 52 are stored. In the program file 51, a program used for distributed processing is- stored. In the input file 52, data to be subjected to distributed processing is stored. The storage device 112 can be recognized and accessed by a computer used as a terminal, for example, the PC 110a through a local bus or the network 150, the program file 51 and the input file 52 inside the storage device 112 are presented as file-format icons to a user though the GUI generating section 12.

The distributed processing device 1 of the present embodiment relates to a device for performing distributed processing using a computational resource through a file operation. Therefore, specifications are not provided here about a method for creating a program which performs parallel processing between a plurality of computational resources, or a method for transferring a program and data to a computational resource to actually start distributed processing on the computational resource. As for these methods, existing various distributed processing techniques are used as they are.

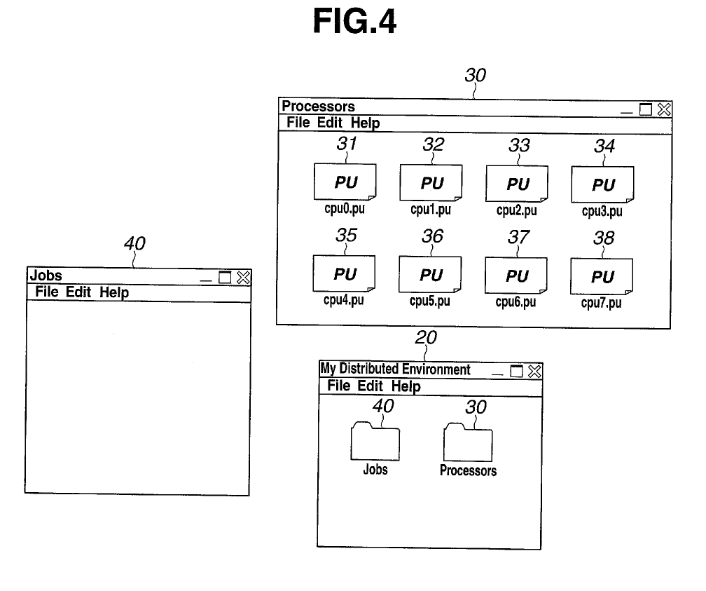

FIG. 4 is an explanatory diagram illustrating an example in which a file system provided by the file processing section is displayed on the display section through a GUI.

As shown in FIG. 4, a file system of the file processing section 11 is provided by a distributed environment folder 20 having a folder name “My Distributed Environment”, which provides two folders, a processor management folder 30 having a folder name “Processors” and a job management folder 40 having a folder name “Jobs” in the distributed environment folder 20.

The file processing section 11 is configured to display in the processor management folder 30 eight computational resources which can be used by the distributed processing device 1, i.e., processor files 31 to 38 which corresponds to the CPUs 121 to 128 respectively. In an example of FIG. 4, none of distributed jobs has yet been executed, and there is no folder in the job management folder 40. Each of the processor files 31 to 38 in the processor management folder 30 is permitted to be read only. Therefore, when starting distributed processing, a user is required to copy the processor files 31 to 38 to be used instead of moving the processor files 31 to 38 from the processor management folder 30.

To newly start distributed processing, a user first creates a new folder in the job management folder 40. The folder created in the job management folder 40 is provided as a job execution folder corresponding to a distributed job. Using an input instruction means such as the mouse 116, the user copies into the job execution folder the program file 51 configured to execute the distributed job, the input file 52 which is a target of the distributed processing, and files required for execution of the distributed job such as the processor files 31 to 38 corresponding to computational resources used for the distributed processing. The file processing section 11 determines whether all files necessary for the job execution folder (that is, required information) are present or not. If the file processing section 11 determines that all the necessary information is present, the distributed processing is started on the computational resources corresponding to the processor files 31 to 38 placed in the job execution folder.

As described above, the file processing section 11 forms an execution management section configured to determine whether or not all the program files 51 and the processor files 31 to 38 which are required for execution of distributed processing are present in the job execution folder, and give an instruction for an execution of the distributed processing if all the required files are determined to be present.

Input file 52 and computational resource required for execution of a certain program are managed as meta information attached to the program. When the program file 51 is copied into the job execution folder, the file processing section 11 can determine whether all necessary information is present or not by referring to the meta information attached to the program.

Meta information just needs to be allowed to be accessed and used by the file processing section 11 as necessary, and is not limited to meta information attached to a program. Meta information may be managed for each program by the file processing section 11. The file processing section 11 can determine whether a file is the program file 51 or not depending on whether or not there is meta information in the file.

In addition, a required amount of memory, an upper limit of a degree of parallelism, and the like which have been found in advance are contained in meta information to give a hint about distributed processing to a user as described later.

For example, there is a case where it has been known that even if a program can process any number of computational resources in parallel in terms of implementation, increase of computational resources hardly improves performance due to a structural reason when there are more than eight computational resources in parallel. In this case, this fact is retained as meta information, which allows the file processing section 11 to generate a virtual file for providing a hint to prompt a user to remove a redundant processor when the user assigns nine or more processors.

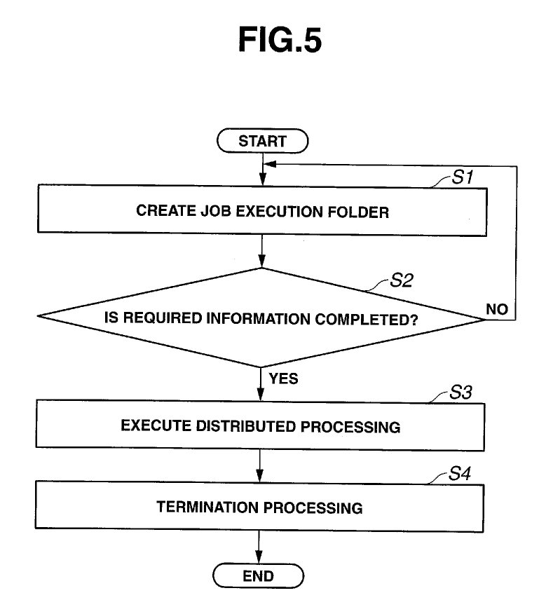

Distributed processing to be executed as described above will be described below. FIG. 5 is a flowchart illustrating an example of a flow of distributed processing.

First, a job execution folder is created (step S1), and whether all information necessary for the distributed processing is present or not is determined (step S2). If all the necessary information is not present in the job execution folder (NO), the process returns to step S1. On the other hand, if all the necessary information is present (YES), the distributed processing is executed (step S3). After execution of the distributed processing, termination processing is executed (step S4) to complete the distributed processing.

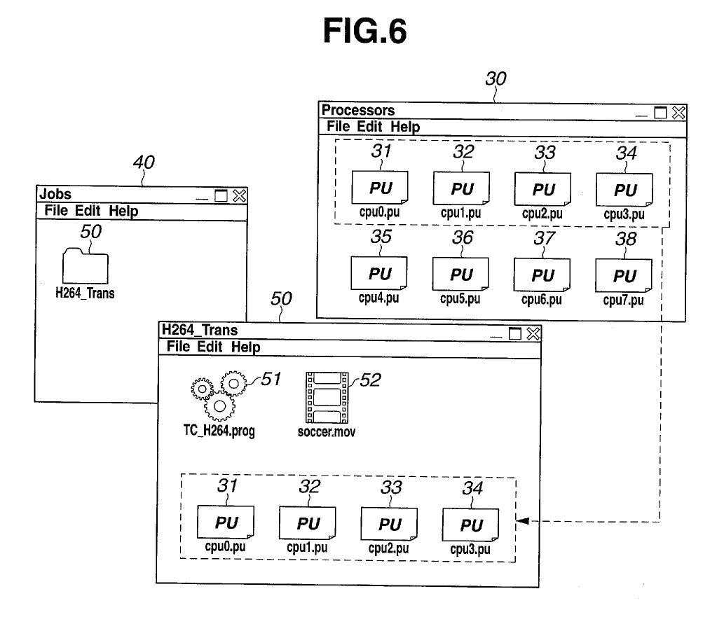

FIG. 6 is an explanatory diagram illustrating a state before start of distributed processing.

As shown in FIG. 6, in a job management folder 40, a job execution folder 50 named “H264_Trans” has been created and displayed. In the job execution folder 50, the program file 51 having a file name “TC_H264.prog” and the input file 52 having a file name “soccer.mov” are copied from the processor management folder 30 and displayed, and further the four processor files 31 to 34 are copied from the storage device 112 and displayed.

The program file 51 is a program configured to transcode, i.e., convert an MP4-format moving image file to an H264-format moving image file. The input file 52 is a target moving image file to be transcoded.

Meta information of the program file 51 is provided which here indicates that a file whose extension is mov is treated as the input file 52, and distributed processing is executed with one input file 52 and four processor files 31 to 34. In this case, it is determined by the file processing section 11 that necessary information is completed, distributed processing using four computational resources corresponding to the processor files 31 to 34 placed in the job execution folder 50 is started, and distributed transcoding of the input file 52 is executed.

Some of programs to execute distributed processing do not require the input file 52. In the case of such a program, distributed processing is started at a time point when a necessary processor file among the program file 51 and the processor files 31 to 38 is copied into the job execution folder 50.

When the distributed processing is started, the file processing section 11 generates, in the job execution folder 50, an output folder for storing an output file, a text file in which distributed job's detailed information such as a load on a computational resource and a detailed progress status of the distributed processing is described (hereinafter referred to as a job information file), and a file which represents a present status of a distributed job as its file name (hereinafter referred to as a state file). The output folder, the job information file, and the state file are virtual files dynamically generated by the file processing section 11. Especially, the job information file is configured such that latest information is read out from the job information file each time a user accesses the job information file. This allows the user to monitor detailed information using a text editor or a pager.

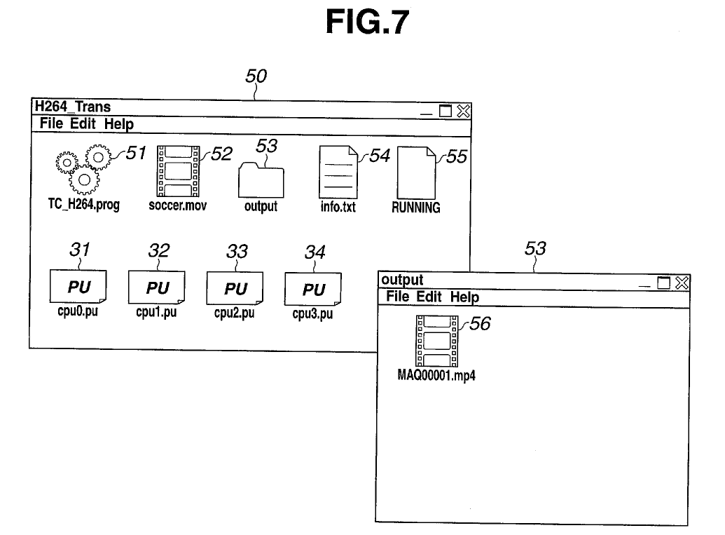

FIG. 7 is an explanatory diagram illustrating a state at a time when distributed processing is started.

As shown in FIG. 7, when it is determined by the file processing section 11 that all necessary information is present, and distributed processing is started, an output folder 53 having a folder name “output ” for showing an output file to a user, a job information file 54 having a file name “info.txt” from which detailed information of a distributed job can be read out, and a state file 55 having a file name “RUNNING” which indicates a distributed job is being executed, are generated in the job execution folder 50.

In the output folder 53, an output file 56 having a file name “MAQ00001.mp4” which is being generated by the program is displayed. The user can directly access the output file 56. For example, the user can check a processing result during generation at any time by opening the output file 56 using video reproduction software or the like supporting streaming reproduction.

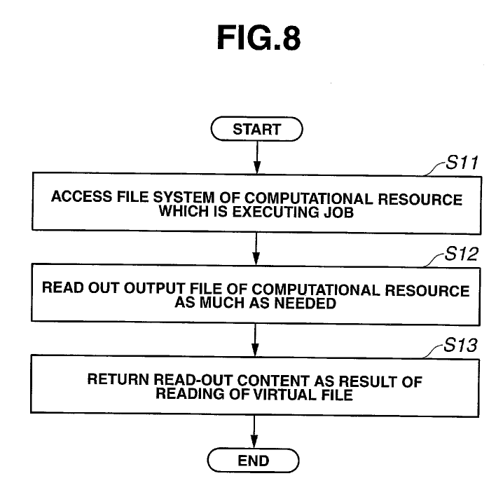

Processing in a case where the above described output file is read out will now be described. FIG. 8 is a flowchart illustrating an example of a flow of the processing in the case where the output file is read out.

First, a file system of a computational resource executing a job is accessed (step S11). An output file of the computational resource is read out as much as needed (step S12). A read-out content is returned as a result of reading of a virtual file (step S13), and this processing is completed.

Conventionally, for a user to retrieve the output file 56, the user needs to additionally use an FTP (File Transfer Protocol) or the like to retrieve the output file of distributed processing generated on a storage area directly connected to a computational resource. Therefore, the user is required to understand matters essentially irrespective of distributed processing, such as a folder structure of each computational resource and a file retrieval method. In the distributed processing device 1 of the present embodiment, since management of distributed processing is performed on the file system, related files such as the output file 56 can be made to look to a user as if the files are in the job execution folder 50, so that the user can acquire the output file 56 and the like without being aware of a folder structure associated with execution of the distributed processing.

In a case where a program supports dynamic change of a degree of parallelism, if a processor file is deleted from the job execution folder 50 or moved to another job execution folder during distributed processing being performed, the distributed processing is reconfigured. Specifically, the distributed processing is carried on only by a computational resource corresponding to a processor file left in the job execution folder 50.

Also, if a processor file is copied or moved from the processor management folder 30, another job execution folder, or the like into the job execution folder during distributed processing being performed, the distributed processing is reconfigured as well, and the distributed processing is carried on in a state where the computational resources include a computational resource corresponding to a newly added processor file.

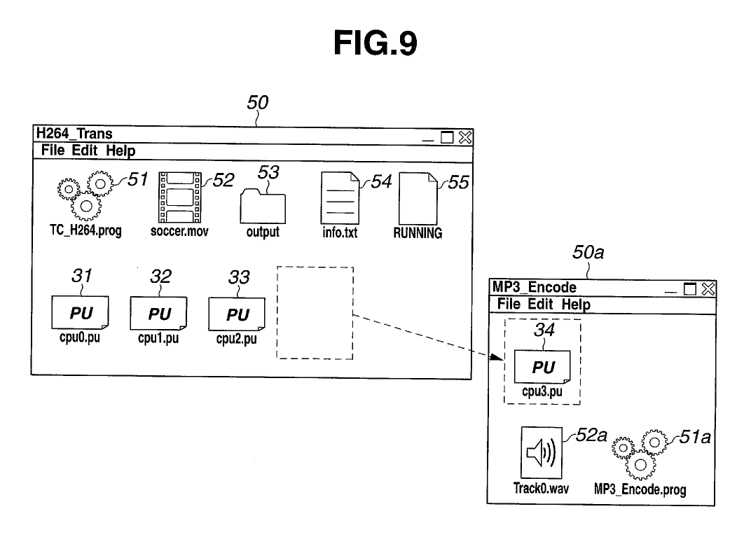

FIG. 9 is an explanatory diagram illustrating a state in which a processor file has been moved out from a job execution folder. In this example, a job execution folder 50a having a folder name “MP3 Encode” different from the job execution folder 50 is created in the job management folder 40 by a user.

As shown in FIG. 9, the processor file 34 is moved from the job execution folder 50 to another job execution folder 50a.

If the program file 51 is a program supporting dynamic change of a degree of parallelism, when one processor file 34 is moved out from the job execution folder 50 to the different job execution folder 50a, the distributed processing executed on four computational resources in parallel until now is suspended, and reconfigured so as to be executed on three computational resources in parallel and then carried on.

On the other hand, if the program file 51 does not support dynamic change of a degree of parallelism, when the processor file 34 is taken out from the job execution folder 50, the distributed processing comes into a suspended state.

Even if the program file 51 is a program supporting dynamic change of a degree of parallelism, if all processor files, the processor files 31 to 34 in the example of FIG. 9, are taken out from the job execution folder 50, the distributed processing comes into a suspended state.

While the distributed processing is suspended, the file processing section 11 changes the file name of the state file 55 to a file name indicating that the distributed processing is being suspended. Thereby, a user can discriminate a state where distributed processing is being suspended from a state where distributed processing is being executed by checking the file name of the state file 55.

If the processor file 34 is placed in the job execution folder 50 again in a state where the processor file 34 has been taken out from the job execution folder 50 and the distributed processing is being suspended, the distributed processing can be resumed on the same computational resources as before. Incidentally, a processor file placed in the job execution folder 50 for resuming may be a processor file corresponding to another computational resource which is different from the processor file 34 used before, that is, the processor file corresponding to the computational resource used before suspension, if the program supports such a different processor file. In other words, an operation to replace a processor file used by a distributed job is performed so that an operation corresponding to migration of the distributed job can be achieved.

When the distributed processing is resumed, the file processing section 11 changes the file name of the state file 55 indicating the suspended state to a file name indicating that the distributed processing is being executed.

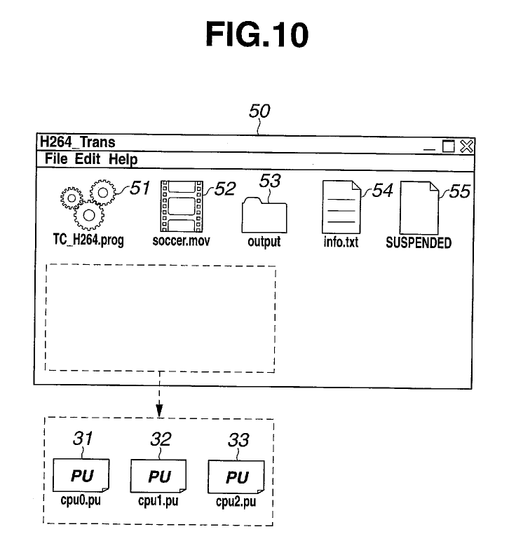

FIG. 10 is an explanatory diagram illustrating a state in which all processor files have been taken out from a job execution folder.

FIG. 10 shows the state in which all the processor files 31 to 33 placed in the job execution folder 50 have been taken out from the job execution folder 50, which is changed from the state of the job execution folder 50 of FIG. 9. Since all the processor files 31 to 33 are taken out from the job execution folder 50, distributed processing is suspended. Accordingly, the file name of the state file 55 is renamed from “RUNNING” indicating that the distributed processing is being executed to “SUSPENDED” indicating that the distributed processing is being suspended.

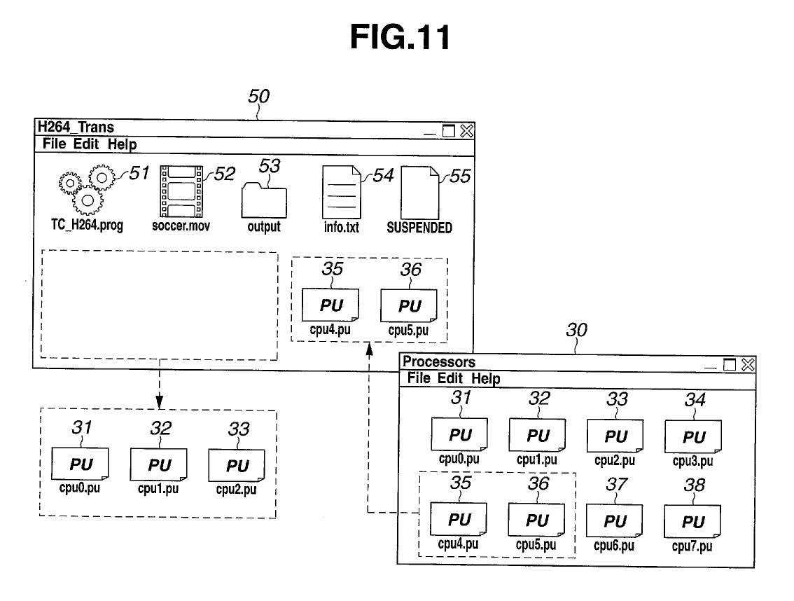

FIG. 11 is an explanatory diagram illustrating a state in which computational resources different from used computational resources have been copied into a job execution folder.

FIG. 11 shows the state where computational resources different from the computational resources used before, i.e., processor files 35 and 36 different from the processor files 31 to 33 which were taken out in FIG. 10 have been copied from the processor management folder 30 into the job execution folder 50, and the distributed processing has been resumed. Since the distributed processing is resumed, the file name of the state file 55 is renamed from “SUSPENDED” indicating that the distributed processing is being suspended to “RUNNING” indicating that the distributed processing is being executed.

In the conventional distributed processing, distributed processing is managed by a scheme in which “a job is assigned to a fixed computational resource”, and therefore it is difficult for a user to achieve efficient use of computational resources even if the program can dynamically change a degree of parallelism when being executed. In the distributed processing device 1 of the present embodiment, distributed processing is managed by a scheme in which “a computational resource is assigned to a job as appropriate”, and therefore if the program supports dynamic change of a degree of parallelism, a user can flexibly reassign a computational resource to be used, and efficient use of computational resources can be achieved.

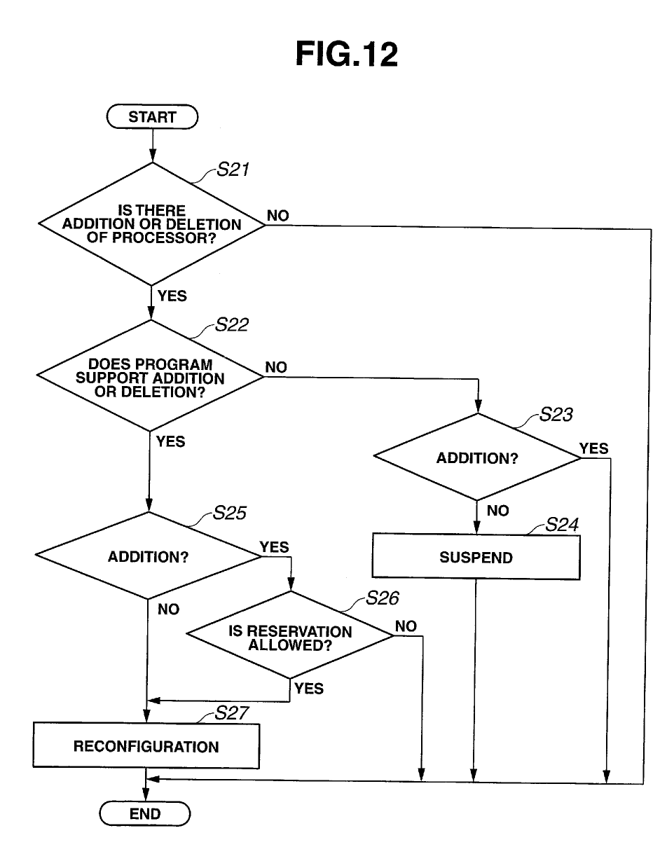

The above described reconfiguration of distributed processing will be described below. FIG. 12 is a flowchart illustrating an example of a flow of processing for reconfiguration of distributed processing.

First, whether or not there is addition or deletion of a processor is determined (step S21). If there is neither addition nor deletion of a processor (NO), the processing is terminated. On the other hand, if there is addition or deletion of a processor (YES), whether or not the program supports the addition or deletion of the processor is determined (step S22). If the addition or deletion of the processor is not supported (NO), whether it is addition or not is determined (step S23). In the case of addition (YES), the processing is terminated. In the case of no addition, that is, deletion (NO), the distributed processing is suspended (step S24), and the reconfiguration processing is terminated. On the other hand, if the addition or deletion is supported in step S22 (YES), whether it is addition or not is determined (step S25). In the case of addition (YES), whether a computational resource can be reserved or not is determined (step S26). If the computational resource cannot be reserved (NO), the processing is terminated. If the computational resource can be reserved (YES), reconfiguration is performed using the corresponding computational resource (step S27), and the processing is terminated. On the other hand, in the case of no addition, that is, deletion (NO) in step S25, reconfiguration is performed using the corresponding computational resource in step S27, and the processing is terminated.

Processing during the suspension of the distributed processing in step S24 will be described below.

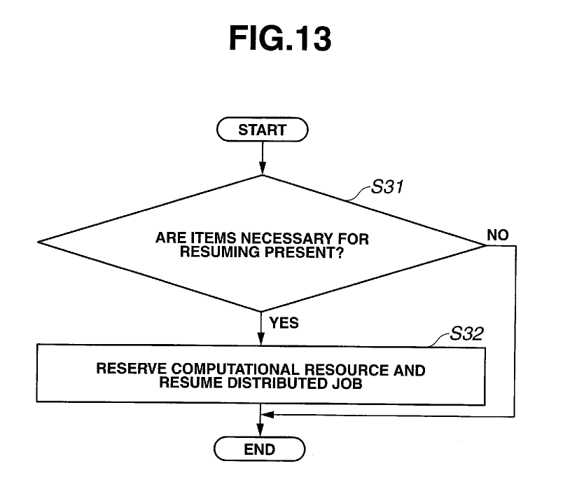

FIG. 13 is a flowchart illustrating an example of the processing during the suspension of the distributed processing.

First, whether all items necessary for resuming are present or not is determined (step S31). If all the items necessary for resuming are not present (NO), the processing is terminated. On the other hand, if all the items necessary for resuming are present (YES), computational resources are reserved and the distributed job is resumed (step S32), and the processing is terminated.

When the distributed processing is completed after the distributed processing is resumed, the file processing section 11 changes the file name of the state file 55 to a file name indicating that the distributed processing is completed.

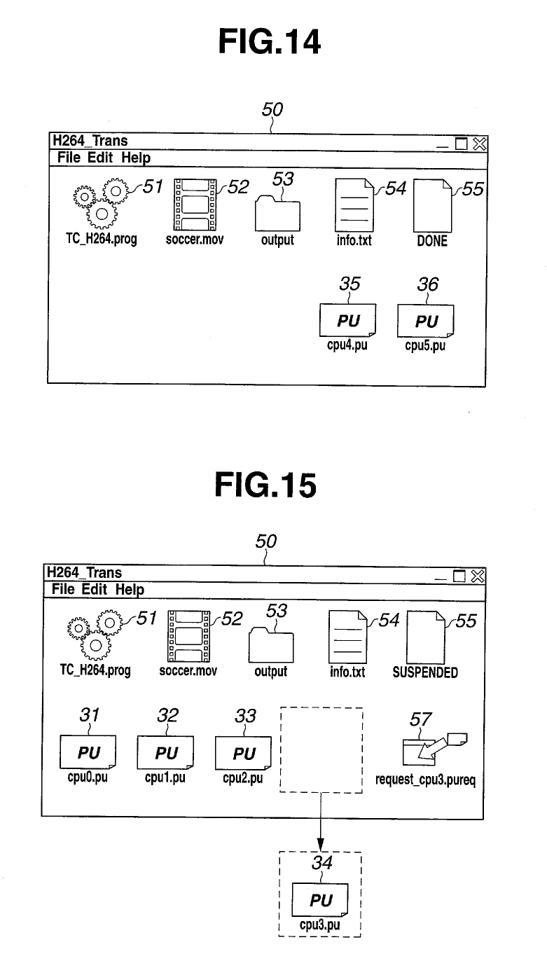

FIG. 14 is an explanatory diagram illustrating a state of a job execution folder at a time when distributed processing is completed. When the distributed processing is completed, the file name of the state file 55 is changed from “RUNNING” indicating that the distributed processing is being executed to “DONE” indicating that the distributed processing is completed as shown in FIG. 14.

Thereby, a user can easily recognize present information of the distributed processing only by looking at the name of the state file 55 without a need for a special interface.

After the distributed processing is completed, the job execution folder 50 remains in a state shown in FIG. 14. If the user places a new input file different from the input file 52 in the job execution folder 50, distributed processing on the new input file is newly started.

As described above, in the distributed processing device 1, a distributed job is represented as a folder, and control and management of the distributed job can be performed by file and folder operations. Therefore, a user can manage distributed processing though a familiar file manager or the like, and is not required to learn a new manner of operation.

Therefore, according to the distributed processing device of the present embodiment, management of distributed processing can be easily performed using a graphical user interface.

As an application example using the distributed processing device 1, the distributed processing device 1 is supposed to be embedded in a device such as a USB memory having a processing unit. If a job management folder provided by such a device is prepared in which a specific program file is held in advance, a user can perform operation using a computational resource on this device only by attaching the USB memory and copies processing target data into the USB memory. In such a case, an external processing device can be used as if allowed only by attachment of a USB memory independently from the OS 161 or an architecture of the PC 110.

### Second Embodiment

Next, a second embodiment will be described. Components of a distributed processing device in the following second to tenth embodiments are the same as the components of the distributed processing device 1 of the first embodiment, and description thereof will be omitted. As described above, in the case where the program does not support dynamic change of a degree of parallelism, when one processor file is taken out from the job execution folder 50 during distributed processing being executed, the distributed processing is suspended at the time.

In the case of a program which does not support migration, in order to resume distributed processing after all processor files are taken out and the distributed processing is suspended, processor files corresponding to originally used computational resources need to be placed in the job execution folder 50.

To properly inform a user of such a circumstance, the file processing section 11 creates a virtual file for prompting a user operation as necessary.

FIG. 15 is an explanatory diagram illustrating a state in which a virtual file has been generated.

FIG. 15 shows a state in which the processor file 34 is taken out from the job execution folder 50 after four computational resources are assigned to a program which does not support dynamic change of a degree of parallelism or migration and then the program is started. In this case, because distributed processing is suspended, the name of the state file 55 is changed to the file name “SUSPENDED” indicating suspension. Further, in the job execution folder 50, a virtual file 57 is generated which requests the taken-out processor file 34 to be placed back in the job execution folder 50 again.

This virtual file 57 is given a file name “request_cpu3.pureq” for requesting the processor file 34 having a file name “cpu3.pu” to be placed back in the job execution folder 50. The virtual file 57 disappears when a copy of the processor file 34 is placed again in the job execution folder 50.

Because the virtual file 57 as described above is generated by the file processing section 11, final operation or determination can be left to a user. Thereby, the user can understand an issue or a solution, and enhance understanding of distributed processing.

### Third Embodiment

Next, a third embodiment will be described.

In a case where a processor file is copied from a job execution folder of a distributed job into another job execution folder during execution of the distributed processing, if a computational resource can be used in parallel by context switching or the like, the file processing section 11 can issue an instruction to use the computational resource corresponding to the processor file in parallel between the original distributed job being executed and a distributed job corresponding to the copy destination job execution folder. Similarly, in a case where a processor file corresponding to a computational resource which is already being used in distributed processing is copied from the processor management folder 30 to a job execution folder, if the computational resource can be used in parallel by context switching or the like, the file processing section 11 can issue an instruction to use the computational resource corresponding to the processor file in parallel between an original distributed job being executed and a distributed job corresponding to the copy destination job execution folder.

On the other hand, a computational resource cannot be used in parallel or is already being used for a maximum number of distributed jobs which can simultaneously use the computational resource, the file processing section 11 generates a special file indicating that a processor file has been reserved (hereinafter referred to as a reservation file) at a time when copying is performed. The reservation file disappears when the computational resource becomes available, and a normal copy of the processor file is generated instead.

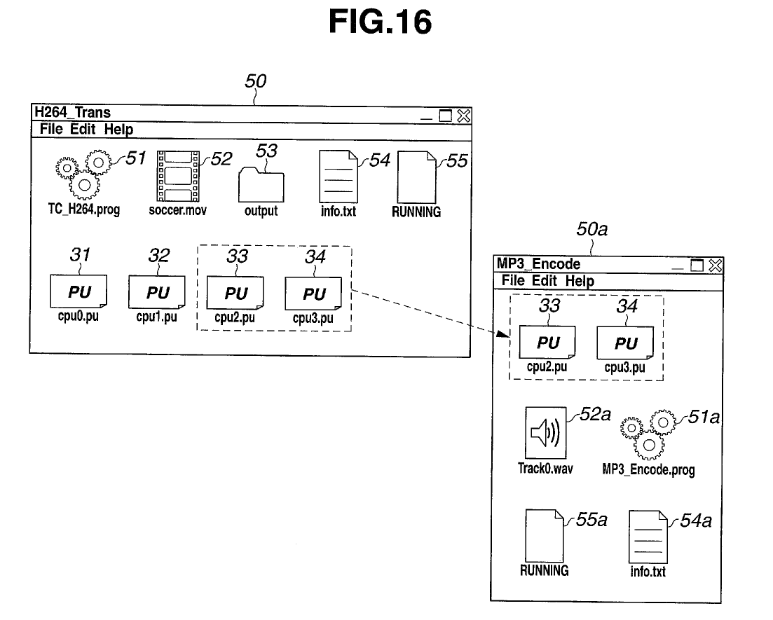

FIG. 16 is an explanatory diagram illustrating a state in which computational resources are simultaneously used.

In FIG. 16, two processor files 33 and 34 of a distributed job managed by the job execution folder 50 are copied into the job execution folder 50a of another distributed job. Thereby, the two copied computational resources can be used by two distributed jobs simultaneously.

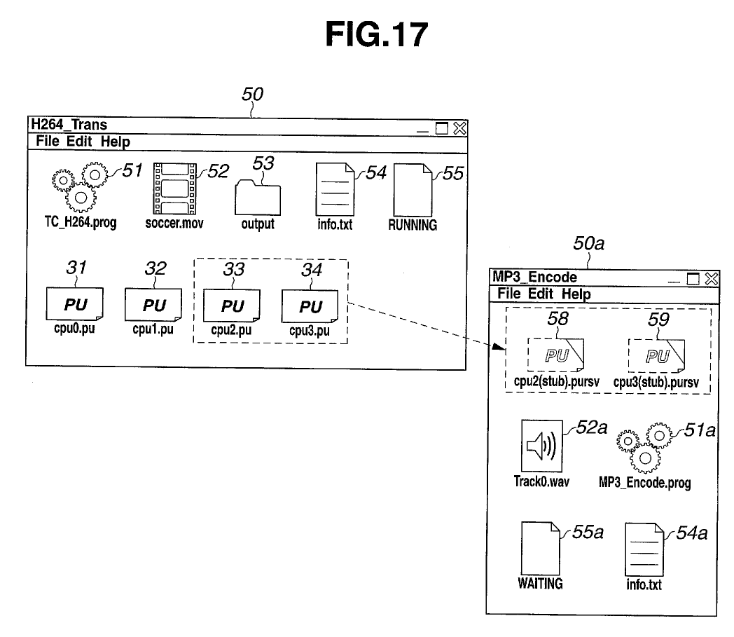

FIG. 17 is an explanatory diagram illustrating a state in which reservation files have been generated.

In FIG. 17, because computational resources used by a distributed job managed by the job execution folder 50 does not support that the computational resources are used by a plurality of jobs simultaneously, when the processor files 33 and 34 are copied, two reservation files 58 and 59 indicating reservations of processors are generated in the job execution folder 50a of another distributed job.

The reservation file 58 has a file name “cpu2(stub).pursv”, and the file 59 has a file name “cpu3(stub).pursv”. In the job execution folder 50a, a state file 55a named “WAITING” is generated which indicates the distributed job is waiting until a reserved computational resource becomes actually available.

Thus, a user is allowed to intuitively give an instruction to use a computational resource simultaneously between different jobs by copying a processor file corresponding to the same computational resource into a plurality of job execution folders. Further, the user is allowed to make a computational resource reserved when the user tries to but cannot make the computational resource shared, so that the user can make a reservation intuitively without a concept of a job queue.

### Fourth Embodiment

Next, a fourth embodiment will be described.

When a distributed job is suspended, the suspended distributed job can be backed up if the job execution folder 50 is copied in whole to a file system or the like on a hard disk. Further, if the backed-up job execution folder 50 is placed in the job management folder 40 again, the job can be resumed. At a stage where distributed processing is suspended, the file processing section 11 generates in the job execution folder 50 a snapshot of the distributed job which is necessary for resuming (hereinafter referred to as a snapshot file). As a result, if the backed-up job execution folder 50 is placed in the job management folder 40 again, the job can be resumed.

Generation processing of a snapshot file will be described below.

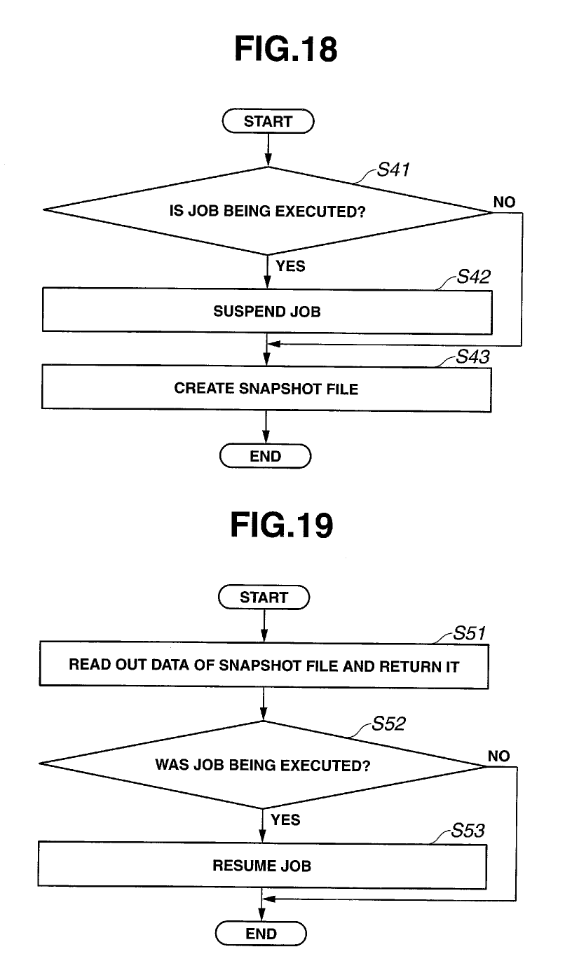

FIG. 18 is a flowchart illustrating an example of a flow of the generation processing of a snapshot file.

First, whether a job is being executed or not is determined (step S41). If the job is not being executed (NO), the processing proceeds to step S43. On the other hand, if the job is being executed, the job is suspended (step S42). Then, a snapshot file is created (step S43), and the processing is terminated.

FIG. 19 is a flowchart illustrating an example of a flow of processing of reading out a snapshot file.

First, data of the snapshot file is read out and returned (step S51). Whether a job was being executed or not is determined (step S52). If the job was not being executed (NO), the processing is terminated. On the other hand, if the job was being executed (YES), the job is resumed (step S53), and the processing is terminated.

Thus, a user can be easily reminded of operation for backing up a snapshot of a job in association with operation for copying the job execution folder 50, and therefore can easily understand the operation for backing up a snapshot of a job.

### Fifth Embodiment

Next, a fifth embodiment will be described.

When the job execution folder 50 itself is deleted, a distributed job is erased exactly. Distributed processing corresponding to the job execution folder 50 is stopped if the distributed processing is being executed, and all files associated with the distributed job placed in the job execution folder 50, such as the program file 51, the input file 52, and the output file 56 being generated, are lost. Further, a computational resource corresponding to a processor file used by the job is released.

Thus, a user can be easily reminded of operation for erasing a job itself including files related to the job in association with operation for erasing the job execution folder 50 being stopped, and therefore can easily understand the operation for erasing a job itself.

### Sixth Embodiment

Next, a sixth embodiment will be described.

If a parameter of processing needs to be specified with respect to the program file 51, a configuration file is placed in the job execution folder 50 together with the program file 51 to specify the parameter.

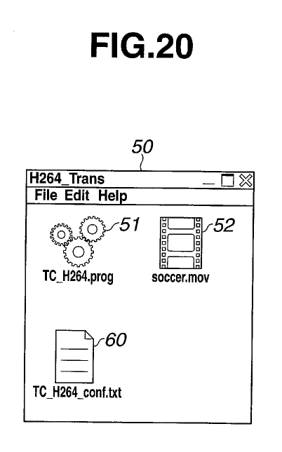

FIG. 20 is an explanatory diagram illustrating a state in which a configuration file has been placed in a job execution folder.

In FIG. 20, a configuration file 60 having a file name “TC_H264_conf.txt” is placed and displayed in the job execution folder 50 together with the program file 51 and the input file 52. The program file 51, which is a transcoder, sets quality of an output moving image, a bit rate, or the like as necessary based on a content described in the configuration file 60. A file name of a file used as the configuration file 60 by the program file 51 is provided as meta information together with the program file 51.

Thus, a user can easily change a setting of processing executed in distributed processing.

### Seventh Embodiment

Next, a seventh embodiment will be described.

If a program which can obtain a degree of progress of processing from a size of an output file is executed, the file processing section 11 generates a virtual file which has a file name corresponding to the output file 56 and displays a progress status of distributed processing (hereinafter referred to as a progress status presentation file) in the output folder 53. In the progress status presentation file, a part of the file name is used to present a user a percentage of a completed part of processing where the entire processing corresponds to 100, an expected finish time or the like, or an ASCII art representation thereof. Further, a content of the progress status presentation is represented as image data, and is presented as a graph or the like to a user when a function of an I/O interface having a file preview function is used.

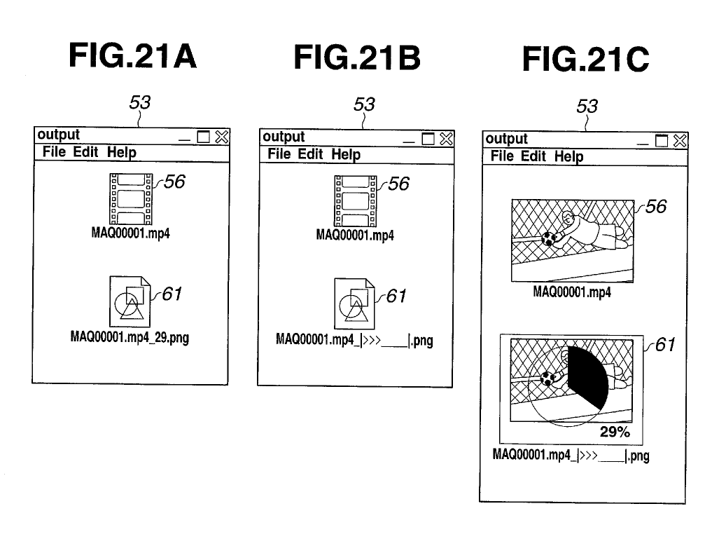

FIGS. 21A, 21B, and 21C are explanatory diagrams illustrating examples of the progress status presentation file.

In an example of FIG. 21A, the output file 56 having a file name “MAQ00001.mp4” in a process of being generated and a progress status presentation file 61 having a file name “MAQ00001.mp4_29.png” which indicates a progress status of the output file 56 in the process of being generated are displayed in the output folder 53. By a part “29” of the file name of the progress status presentation file 61, a fact that 29% of distributed processing is completed at present is presented to a user.

In an example of FIG. 21B, instead of a numeral “29”, a graph is represented using an ASCII art “|>>>|”, which indicates a progress status.

In an example of FIG. 21C, a content of a file is displayed as an icon using a preview function of an I/O interface. In this case, the content of the progress status presentation file 61 includes both a percentage number and a circular graph, so that a progress status of distributed processing can be presented to a user in a more easily understandable form than a file name.

A technique for recognizing a progress status of a certain program from an outside of the program is described in meta information.

Generation processing of the progress status presentation file 61 will now be described.

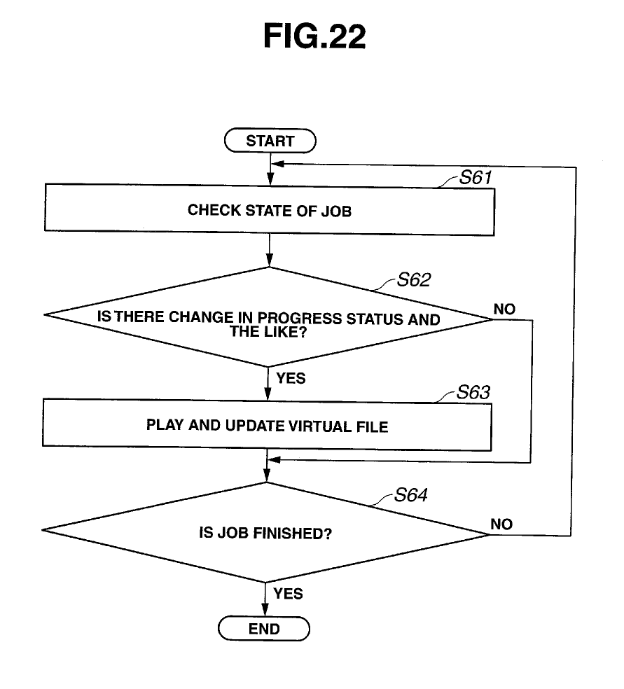

FIG. 22 is a flowchart illustrating an example of a flow of generation processing of the progress status presentation file.

First, a state of a job is checked (step S61). Whether or not there is a change in a progress status is determined (step S62). If there is no change in the progress status (NO), the processing proceeds to step S64. If there is a change in the progress status (YES), the progress status presentation file, which is a virtual file, is played and updated (step S63). Then, whether the job is finished or not is determined (step S64). If the job is not finished, the process returns to step S61, and the processing is repeated in a similar way. On the other hand, if the job is finished (YES), the processing is terminated.

By the above described processing, a user can easily check the progress state of distributed processing without a need to start up special software. In addition, the user can visually check the progress state of distributed processing using an ASCII art or a graph, and therefore can check the progress state of distributed processing more easily.

### Eighth Embodiment

Next, an eighth embodiment will be described.

The file processing section 11 generates a virtual file having a file name which corresponds to a processor file and indicates information of a computational resource (hereinafter referred to as a computational resource information presentation file). In a manner similar to the case of the progress status presentation file described in the seventh embodiment, in the computational resource information presentation file, a part of the file name is used to present a user a load on a computational resource, the number of the computational resources being used the number of reservations of the computational resource, and the like. In addition, the file processing section 11 represents a content of the file as an image to present the user the load on a computational resource, the number of the computational resources being used the number of reservations of the computational resource, and the like.

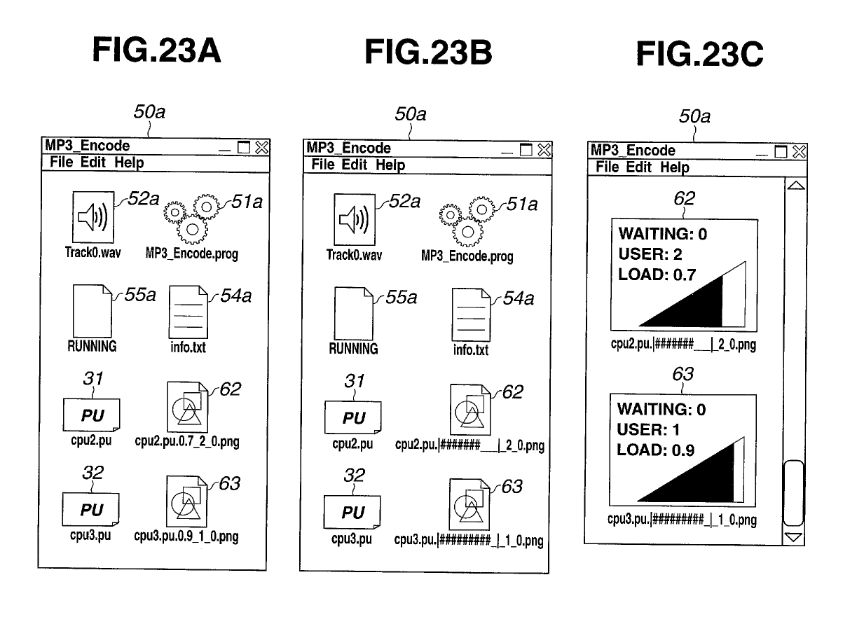

FIGS. 23A, 23B, and 23C are explanatory diagrams illustrating a state in which a computational resource information presentation file has been generated.

In an example of FIG. 23A, a file name of the computational resource information presentation file 62 of the processor file 31 corresponding to cpu2.pu is “cpu2.pu.0.7_2_0.png”. By checking the file name, a user can recognize that a load on a corresponding computational resource is 0.7, the number of the computational resources being used is 2, and the number of reservations of the computational resource is 0. In an example of FIG. 23B, a load section is represented as a graph using an ASCII art. In an example of FIG. 23C, images are previewed.

Update of the computational resource information presentation file 62 can be achieved by processing as in the flowchart of FIG. 22.

By the above described processing, a load on a computational resource and the like can be easily recognized from a file name of the computational resource information presentation file 62 without a need to start up special software. In addition, a user can visually check the load on the computational resource and the like using an ASCII art or a graph, and therefore can check the load on the computational resource and the like more easily.

### Ninth Embodiment

Next, a ninth embodiment will be described.

In a case where a certain program has been allocated to a distributed job, if a processor file corresponding to a computational resource which cannot be used by the certain program is copied into a job execution folder of the distributed job, the file processing section 11 generates a virtual file which uses its file name or icon to instruct to delete the processor file corresponding to the computational resource which cannot be used.

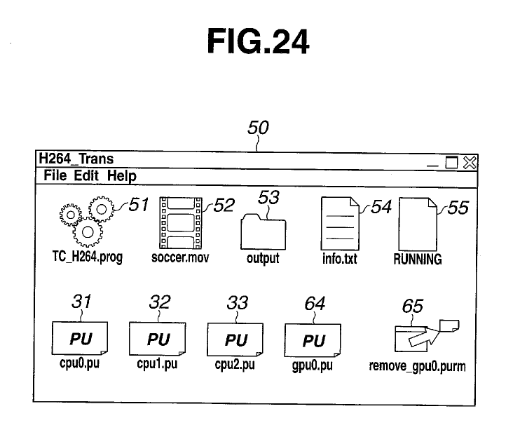

FIG. 24 is an explanatory diagram illustrating a state in which a virtual file has been generated.

An example of FIG. 24 shows that a GPU represented by a processor file 64 named “gpu0.pu” is allocated to the job execution folder 50 to which a program that does not support use of the GPU has been allocated. In this example, a virtual file 65 having a file name “removegpu0.purm” is generated which instructs to delete the processor file 64 having a file name “gpu0.pu”. From the file name and an icon of the virtual file 65, a user can recognize that the processor file 64 needs to be deleted.

Because the virtual file 65 as described above is generated by the file processing section 11, final operation or determination can be left to the user. Thereby, the user can understand an issue or a solution, and enhance understanding of distributed processing.

### Tenth Embodiment

Next, a tenth embodiment will be described.

In a case where there are a plurality of types of computational resources managed by the distributed processing device 1, and executable computational resources are different depending on programs, a type of architecture or node or the like is contained in a file name of a processor file so that a corresponding computational resource can be identified among other computational resources.

In a case where computational resources managed by the distributed processing device 1 can be grouped in units of physical connection such as core units or cluster units, processor files in a processor management folder are hierarchized on the basis of groups so that a user can make a selection in consideration of groups when selecting computational resources. For example, the user is allowed to select only computational resources in a single group, or on the contrary, select computational resources one by one from different groups intentionally. In this case, a name of each processor file and a directory name of each layer are adapted to contain a hierarchical name so that a same type of computational resources belonging to different groups can be used by same distributed processing. This is because, if hierarchical names are not contained in file names, files having a same name exist under different directories, and the names collide and overwriting occurs when those files are copied into a job execution folder.

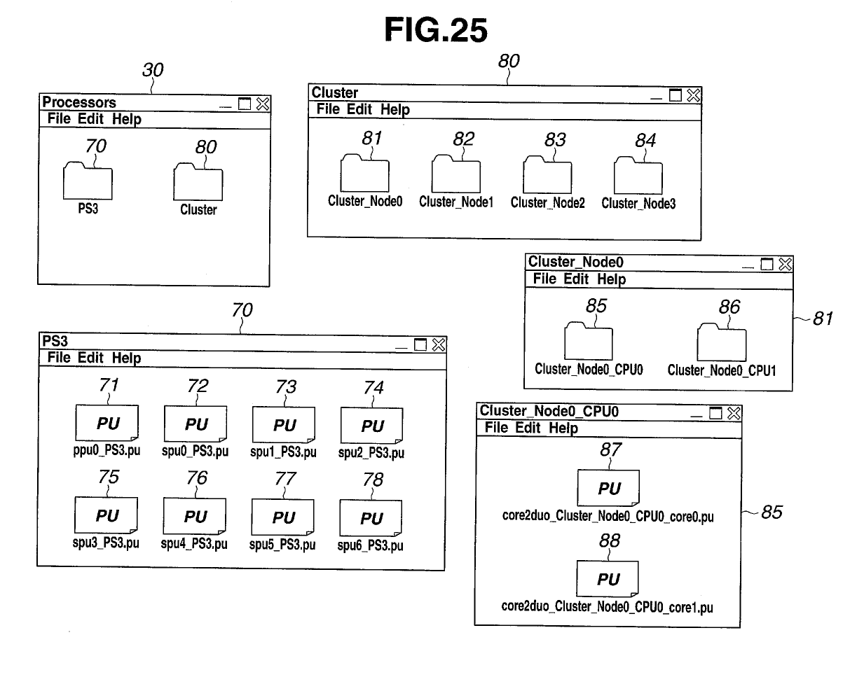

FIG. 25 is an explanatory diagram illustrating an example in which a processor management folder is hierarchized.

FIG. 25 shows a status in the processor management folder 30 in a case where the distributed processing device 1 is used to manage, for example, a PlayStation 3 (R) and a PC cluster composed of four nodes. In this case, under the processor management folder 30, processor files are not placed directly, but exist as two computational resource groups: “PS3” representing the PlayStation 3 connected through the network 150 and “Cluster” representing the PC cluster composed of four nodes also connected to the network. In a PS3 folder 70, seven SPEs and one PPE in a CellBE chip provided in the PS3, a total of eight cores, are displayed as processor files 71 to 78. A user can identify a type of each processor and a layer to which each processor belongs by its file name.

Further, nodes and CPUs themselves are represented as folders because a cluster folder 80 contains four nodes, each of which is equipped with two CPUs, and each of the CPU has a dual-core configuration.

In other words, the Cluster folder 80 has two folders 85 and 86, and the folder 85 has two processor files 87 and 88.

In a folder corresponding to each node, processor files are placed in units of cores. Thereby, even in a case where distributed processing is performed by four cores in parallel in a single cluster, a user can make a selection such as by selecting four cores of one node so that close communication is allowed between the same cores, or selecting one core from each of four nodes so that an available amount of memory is increased as a whole.

As described above, since a folder is assigned to computational resources positioned on each single chip and arranged in a hierarchical structure, a user can select an efficient combination of computational resources from many computational resources.

Further, since a file name corresponding to a type of a computational resource is assigned to a file when the computational resource is presented as the file to a user, the user can recognize a difference in processor architecture, available amount of memory or the like between computational resources when selecting a computational resource, and therefore can select a proper computational resource.

Any steps of the flowcharts in this specification may be reordered, executed in parallel, or executed in a different order for each execution without departing from the essence thereof.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A distributed processing device comprising:
a graphical user interface generating section configured to generate a folder or a directory in which a program icon of a program used for distributed processing and a processor icon corresponding to a computational resource for executing the distributed processing are to be put; and
an execution management section configured to give an instruction for an execution of the distributed processing if the program icon and the processor icon which are required for executing the distributed processing are put in the folder or the directory.

2. The distributed processing device according to claim 1, wherein the execution management section detects addition of the processor icon to or deletion of the processor icon from the folder or the directory, and changes the number of processor icon used in distributed processing being executed according to the addition or the deletion of the processor icon.

3. The distributed processing device according to claim 1, wherein the execution management section suspends the distributed processing being executed if all of the processor icons are deleted from the folder or the directory, and resumes the suspended distributed processing if any one of all of the processor icons or a processor icon other than all of the processor icons is added to the folder or the directory.

4. The distributed processing device according to claim 1, wherein when the processor icon used in the distributed processing being executed is copied into a folder or a directory performing different distributed processing, the execution management section uses the computational resource corresponding to the copied processor icon in the different distributed processing in parallel.

5. The distributed processing device according to claim 4, wherein if the execution management section cannot use the computational resource corresponding to the copied processor icon in the different distributed processing in parallel, the execution management section generates a reservation file indicating that the computational resource corresponding to the copied processor icon is reserved.

6. The distributed processing device according to claim 1, wherein when the folder or the directory is deleted during execution of the distributed processing, the execution management section stops the distributed processing and releases the computational resource which was executing the distributed processing.

7. The distributed processing device according to claim 1,
wherein the program used for the distributed processing has meta information, and
wherein the execution management section determines whether all of the program icon and the processor icon which are required to execute the distributed processing are present in the folder or the directory, by referring to the meta information.

8. The distributed processing device according to claim 1, wherein the execution management section generates, in the folder or the directory, an output folder or an output directory in which an output file is stored, a text file in which a load on the computational resource and a progress status of the distributed processing are described, and a state file configured to indicate a state of the distributed processing using a file name.

9. The distributed processing device according to claim 1, wherein the execution management section generates a computational resource information presentation file having a file name indicating information of the computational resource, in the folder or the directory.

10. The distributed processing device according to claim 9, wherein the file name of the computational resource information presentation file includes the load on the computational resource, the number of the computational resources being used and the number of reservations of the computational resource.

11. A distributed processing method comprising:
generating a folder or a directory in which a program icon of a program used for distributed processing and a processor icon corresponding to a computational resource for executing the distributed processing are to be put, and displaying a graphical user interface for presenting the folder or the directory to a user on a display device; and
executing the distributed processing if the program icon and the processor icon which are required for executing the distributed processing are put in the folder or the directory.

12. The distributed processing method according to claim 11, comprising detecting addition of the processor icon to or deletion of the processor icon from the folder or the directory, and changing the number of parallel processes of the distributed processing being executed according to the addition or the deletion of the processor icon.

13. The distributed processing method according to claim 11, comprising suspending the distributed processing being executed when all of the processor icons are deleted from the folder or the directory, and resuming the suspended distributed processing when any one of all of the processor icons or a processor icon other than all of the processor icons is added to the folder or the directory.

14. The distributed processing method according to claim 11, comprising, when the processor icon used in the distributed processing being executed is copied into a folder or a directory performing different distributed processing, using the computational resource corresponding to the copied processor icon in the different distributed processing in parallel.

15. The distributed processing method according to claim 14, comprising generating a reservation file indicating that the computational resource corresponding to the copied processor icon is reserved, if the computational resource corresponding to the copied processor icon cannot be used in the different distributed processing in parallel.

16. The distributed processing method according to claim 11, comprising stopping the distributed processing and releasing the computational resource which was executing the distributed processing when the folder or the directory is deleted during execution of the distributed processing.

17. The distributed processing method according to claim 11, wherein the program used for the distributed processing has meta information, and comprising determining whether or not all of the program icon and the processor icon which are required to execute the distributed processing are present in the folder or the directory by referring to the meta information.

18. The distributed processing method according to claim 11, comprising, when execution of the distributed processing is started, generating, in the folder or the directory, an output folder or an output directory in which an output file is stored, a text file in which a load on the computational resource and a progress status of the distributed processing are described, and a state file configured to indicate a state of the distributed processing using a file name.

19. The distributed processing method according to claim 11, comprising generating a computational resource information presentation file having a file name indicating information of the computational resource, in the folder or the directory.

20. The distributed processing method according to claim 19, wherein the file name of the computational resource information presentation file includes the load on the computational resource, the number of the computational resources being used and the number of reservations of the computational resource.
